(19) United States
(12) Patent Application Publication
(10) Pub. No.: US 2012/0028527 A1
(43) Pub. Date: Feb. 2, 2012

(54) Ultra Low Formaldehyde Binders for Nonwoven Substrates

(75) Inventors: John Richard Boylan, Bethlehem, PA (US); Conrad William Perry, Wescosville, PA (US)

(73) Assignee: Wacker Chemical Corporation, Adrian, MI (US)

(21) Appl. No.: 12/846,954

(22) Filed: Jul. 30, 2010

(51) Int. Cl. D04H 5/04; C08L 5/08

(52) U.S. Cl. 442/71; 524/29; 442/59; 442/155

(57) ABSTRACT

A low-formaldehyde binder composition for increasing wet and dry tensile strength of a nonwoven substrate includes:
a) an aqueous vinyl acetate ethylene copolymer dispersion employing a nonionic, cationic or amphoteric dispersion stabilizer,
b) chitosan, and
c) one or more surfactants not including the dispersion stabilizer.

The binder composition has a free formaldehyde content no greater than 10 ppm, at least 90 wt % of the one or more surfactants are nonionic, cationic, amphoteric or a combination of these, and the copolymer in the dispersion is free of formaldehyde-generating moieties.

### BACKGROUND OF THE INVENTION

Vinyl acetate ethylene (VAE) copolymer dispersions containing N-methylolacrylamide (NMA) as a self-crosslinking functional monomer are often applied to nonwoven substrates to provide good dry and wet tensile strength, as well as good water absorptivity. Examples of such substrates include airlaid nonwoven substrates used for wet wipe end-use applications. Wet wipes have an aqueous composition, such as a lotion, impregnated into the substrate to afford a wet texture.

During the VAE crosslinking, however, formaldehyde is produced as an undesirable by-product. In addition, formaldehyde is in many cases also present in the dispersion prior to crosslinking due to the use of sodium formaldehyde sulfoxylate as a redox radical initiator in forming the VAE copolymer. Formaldehyde may also be present due to the use of certain preservatives. The presence of formaldehyde in the dispersion, as well as in the substrate after the crosslinking reaction, is, however, undesirable for both the manufacturer of the substrate as well as the end use consumer. Efforts to use VAE resins that do not contain NMA or other crosslinking monomers, however, have typically resulted in insufficient dry and wet tensile strength and insufficient water absorptivity. Thus, a need exists for methods and compositions capable of providing acceptable wet and dry tensile strength and absorptivity without producing formaldehyde.

### SUMMARY OF THE INVENTION

In one aspect, the invention provides a low-formaldehyde binder composition for increasing wet and dry tensile strength of a nonwoven substrate. The composition includes

a) an aqueous vinyl acetate ethylene copolymer dispersion employing a nonionic, cationic or amphoteric dispersion stabilizer,

b) chitosan, and

c) one or more surfactants not including the dispersion stabilizer.

The binder composition has a free formaldehyde content no greater than 10 ppm, at least 90 wt % of the one or more surfactants are nonionic, cationic, amphoteric or a combination of these, and the copolymer in the dispersion is free of formaldehyde-generating moieties.

In another aspect, the invention provides a nonwoven product that includes a nonwoven substrate treated with the binder composition of this invention. In some aspects, the invention provides such a product impregnated with an aqueous composition.

### DETAILED DESCRIPTION OF THE INVENTION

The invention provides compositions and methods for providing good wet and dry strength, and absorptivity, to nonwoven substrates with little or no formation of formaldehyde. It is now disclosed that using a three-component combination of chitosan (a modified natural polysaccharide polymer), one or more nonionic and/or cationic and/or amphoteric wetting surfactants, and a low-formaldehyde non-NMA containing VAE provides good wet and dry strength properties and good hydrophilic properties when applied as a binder to cellulose fiber (for example, when the nonwoven substrate is paper) or to cellulose/synthetic fiber nonwoven substrates. Unlike NMA-containing VAE strength agents, this combination results in very low (approaching 0 ppm) levels of free formaldehyde in both the dispersion and in a nonwoven substrate treated with the composition as a binder. In contrast, use of a typical NMA-containing dispersion results in a substrate with >10 ppm of formaldehyde, and the dispersions themselves may typically contain at least 40 ppm of free formaldehyde as measured by ASTM D5910-96. (The formaldehyde level in treated substrates can be measured with a modified version of this method in which the substrate undergoes a water extraction prior to testing via D5910-96.)

As will be seen in the Examples, the combination of VAE and chitosan produces a surprising cooperative effect, providing significantly greater dry and wet tensile strength than would have been expected. A wetting surfactant is included to provide an adequate rate of absorption of aqueous liquids for nonwoven substrates treated with the composition. The treated nonwoven substrate has a high level of wet and dry tensile strength and yet extremely low levels of free formaldehyde. These properties make it useful for wet or dry wipe products. Each of these components will now be described, followed by a description of suitable compositions and their use.

### VAE Copolymer Dispersion

For purposes of this invention, the VAE copolymer does not contain units of NMA or any other methylol-containing monomer, or any monomer that produces formaldehyde either in the binder composition or on a treated substrate. As a result, the copolymer is free of formaldehyde-generating moieties. It is also preferred that the copolymer be prepared by initiating the vinyl acetate/ethylene dispersion polymerization with an initiator that does not contain formaldehyde-producing moieties, as opposed to using the more typical redox pair initiator employing formaldehyde-producing sodium formaldehyde sulfoxylate (SFS) as the reducing agent. In general, suitable non-formaldehyde generating reducing agents for redox pairs include, as non-limiting examples, those based on ascorbic, bisulfite, erythorbate or tartaric chemistries as known in the art, and a commercial reducing agent known as BRUGGOLITE® FF6M manufactured by Bruggeman Chemical of Heilbronn, Germany. Non-redox initiators may also be used, such as persulfates, peroxides and azo-type initiators, all of which are well known in the art.

One suitable VAE copolymer is a nonionic polyvinyl alcohol (PVOH) stabilized VAE known as VINNAPAS® RB18, available from Wacker Chemie AG of Munich, Germany. Free formaldehyde levels of VINNAPAS® RB18 as a 55% nonvolatiles dispersion as measured via ASTM D5910-96—Determination of Free Formaldehyde in Dispersion Polymers by Liquid Chromatography have averaged 6.3 ppm, whereas similar PVOH stabilized dispersions produced with SFS have measured >40.0 ppm. The use of PVOH or some other nonionic, cationic or amphoteric dispersion stabilizer, rather than an anionic one, is preferred for reasons that will be described further below. Suitable stabilizers include polymeric stabilizers such as cellulosic compounds (for example, hydroxyethylcellulose), dextrins, polyvinylpyrrolidone, and polyacrylamide. Other useful stabilizers may include cationic, amphoteric or nonionic surfactants. Examples include ethoxylated fatty amines, amine oxides, ethylene oxide/propylene oxide block copolymers, alcohol ethoxylates, alkylphenol ethoxylates, glycol esters, amides, benzyl quaternary ammonium compounds, amphoacetates, amphopropionates, amphosulfonates, and aminopropionates.

The function of the VAE in the formulation is to provide the nonwoven substrate with a higher level of dry tensile strength, beyond what the chitosan can provide as the sole binder. The low glass transition temperature of the VAE (Tg=17° C., in the case of VINNAPAS® RB18) is also expected to provide the nonwoven substrate with improved stretch and elongation properties, overcoming the brittle nature of the chitosan (Tg>140° C.). These properties are important when handling the nonwoven substrate on equipment that is used to convert it into a final product.

### Chitosan

Chitosan is a linear homopolymer of β-(1,4)-2-amino-2-deoxy-D-glucose. It is prepared by the alkaline deacetylation of chitin obtained from the shells of crabs. Its structure is as follows:

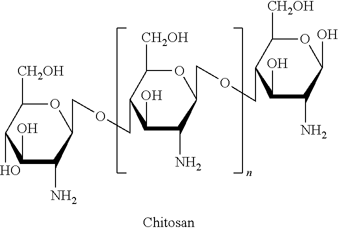

The chitosan provides significant wet and dry tensile strength to the nonwoven substrate. But, as can be seen by the structure, chitosan does not form or emit formaldehyde.

Chitosan is typically supplied in powder form and is dispersible in water, but insoluble. It can be solubilized by adding acetic acid at a 1% level to the dispersed chitosan powder. One grade of chitosan found useful during the development of this invention was supplied by Aldrich and had the following specifications, although other chitosans may also perform well:

| | |
|---|---|
| % deacetylation: | >75% |
| Viscosity of 1% solution | 20 to 200 cps |
| Particle size: | <150 microns |

### Wetting Surfactant

One or more wetting agents are necessary to overcome the hydrophobic nature of the chitosan and provide the nonwoven substrate with an absorption rate that will allow the nonwoven substrate to absorb water or other aqueous compositions (for example an aqueous lotion) when used in a wet wipe.

Wetting surfactants for this invention must be substantially nonionic, cationic, amphoteric, or a combination of these, to be compatible with the cationic chitosan. Substantial amounts of anionic surfactants are incompatible with the chitosan, and therefore at least 90 wt % of the one or more surfactants is/are nonionic and/or cationic and/or amphoteric, or at least 95 wt %, or at least 98 wt %. In some cases, the one or more surfactants is/are 100% nonionic and/or cationic and/or amphoteric. The inventors have found that anionic wetting agents are ineffective in improving absorption rate in the compositions of this invention, even though anionic wetting agents are widely used and effective in systems where crosslinkable NMA-containing VAE binders are used. Several types of nonionic wetting surfactants are suitable for use and contribute no formaldehyde to the nonwoven substrate. One type includes ethoxylated acetylenic diols, for example SURFYNOL® 465 (Air Products & Chemicals, Allentown, Pa.). Also useful are branched alcohol ethoxylates such as RHODASURF® BC 720, a tridecyl alcohol ethoxylate, and linear alcohol ethoxylates such RHODASURF® LA-9 (Rhodia, Cranbury, N.J.). Other suitable wetting agents include ethylene oxide/propylene oxide block copolymers, alkylphenol ethoxylates, amine oxides, ethoxylated fatty amines, benzyl quaternary ammonium compounds, amphoacetates, amphopropionates, amphosulfonates, and aminopropionates.

### Binder Composition

The VAE, chitosan and surfactant together typically constitute from 2 wt % to 25 wt % of the binder composition when formulated for nonwoven application, with water (and acetic acid to dissolve the chitosan) making up the balance. More typically, the range is from 5 wt % to 15 wt %, or from 7 wt % to 13 wt %.

The VAE copolymer and its associated emulsion stabilizer(s) will typically constitute at least 77 wt % of the total nonvolatiles in the binder composition, or at least 85 wt %, or at least 90 wt %. It will typically constitute at most 99.7 wt %, or at most 98 wt %, or at most 97 wt %. As used herein, the term “nonvolatiles” refers to the residue remaining after drying a composition at ≧0.100° C. until constant weight is reached, as measured by a CSC Digital Moisture Balance, manufactured by CSC Scientific company, Inc., Fairfax, Va.

The chitosan will typically constitute at least 0.2 wt % of the total nonvolatiles in the binder composition, or at least 1 wt %, or at least 2 wt %. It will typically constitute at most 20 wt %, or at most 15 wt %, or at most 10 wt %.

The surfactant will typically constitute at least 0.1 wt % of the total nonvolatiles in the binder composition, or at least 0.2 wt %, or at least 0.3 wt %. It will typically constitute at most 3 wt %, or at most 2.5 wt %, or at most 2 wt %.

### Application to Substrates

The binder compositions of this invention may be applied to a nonwoven substrate via any of several application methods, including but not limited to spraying, saturation, foaming and printing. The fibrous nonwoven substrate can be produced with various methods including but not limited to airlaid, wet laid, carding, and hydroentanglement.

The fibrous material used in the nonwoven substrate can be a natural fiber such as (but not limited to) cellulose fiber, or a synthetic fiber including but not limited to one or more of polyester, polyethylene, polypropylene and polyvinyl alcohol, or viscose fiber, or a combination of any of these.

### EXAMPLES

### Binder Composition for Spraying

A binder suitable for spray application to an airlaid nonwoven substrate was prepared by blending the following ingredients, producing a 10% nonvolatiles composition:

| | | Wt % of |
|---|---|---|
| | Amount | Total |
| Ingredient | (grams) | Nonvolatiles |
| *VINNAPAS ® | 346 | 95% |
| RB18 | | |
| Chitosan | 8 | 4% |
| Surfactant | 2 | 1% |
| Water | 1628 | N/A |
| Acetic Acid | 16 | N/A |
| Total | 2000 | 100% |

*55% nonvolatiles

### Nonwoven Spray Application/Testing

The formulation described above was sprayed onto both sides of a cellulose fiber/synthetic fiber nonwoven substrate having a basis weight of 85 g/m². The binder add-on was targeted for 10% dry binder blend on the weight of dry substrate. The sprayed substrates were dried in a through-air oven at a temperature of 320° F. (160° C.) for three minutes. The treated nonwoven substrates were then evaluated for dry and wet tensile breaking strength according to ASTM method D 5035-95, and the absorption properties were tested with a Sherwood Instruments ATS 600 Absorbency Testing systems absorbency tester. This instrument measures the rate of water absorption and the maximum absorbance capacity of a nonwoven substrate.

### Example 1

### Free Formaldehyde Quantities in VAE Dispersions

Table 1 below illustrates the amount of free formaldehyde found in VAE dispersions where either 1) a sodium formaldehyde sulfoxylate based redox initiator or 2) a redox initiator not containing formaldehyde-forming moieties (“NFI”) is used as the free radical initiator in forming the VAE copolymer. Free formaldehyde levels of dispersion polymers prepared with N-methylolacrylamide are also shown, as well as for a nonionic polyvinyl alcohol stabilized dispersion (VINNAPAS® RB18) prepared with a redox initiator not containing formaldehyde-forming moieties. VINNAPAS® products may be obtained from Wacker Chemie AG, Munich, Germany.

TABLE 1

| | Free Formaldehyde |
|---|---|
| Dispersion | (ppm)* |
| VINNAPAS ® 192 | 43.5 |
| (NMA/NFI) | |
| VINNAPAS ® EN1267 | 45.7 |
| (NMA/NFI) | |
| VINNAPAS ® RB18 | 6.3 |
| PVOH/NFI | |
| Commercial VAE | 96.8 |
| PVOH/SFS | |

*ASTM method D 5035-95
NMA = N-methylolacrylamide
SFS = sodium formaldehyde sulfoxylate
PVOH = poly(vinyl alcohol)
NFI = non-formaldehyde initiator

As can be seen, the nonionically-stabilized VINNAPAS® RB18 prepared with a non-formaldehyde initiator and polyvinyl alcohol had a much lower formaldehyde content than the dispersions prepared with SFS or NMA.

### Example 2

### Contribution of Individual Components to Physical Properties

The three components used to make up the formulation according to the invention were spray applied to an airlaid nonwoven substrate as individual components and in combinations to determine their effects on the physical properties of the nonwoven substrate. The untreated nonwoven substrate had the following characteristics:

Basis Weight—˜85 grams/m²
Fiber composition

### Cellulose—88%

Synthetic bi-component fiber—12% (polyester core surrounded by polyethylene sheath)

### Caliper—0.81 mm

Cross Direction Dry Tensile Strength—590 grams/5 cm
Cross Direction Wet Tensile Strength—330 grams/5 cm

The procedure for preparing dissolving the chitosan and blending all ingredients together was as follows:
1. Disperse the chitosan in the water with agitation.
2. Add the acetic acid to the dispersed chitosan and continue agitation as the chitosan dissolves.
3. Add the surfactant to the dissolved chitosan.
4. Under agitation, add the chitosan/surfactant blend to the VINNAPAS® RB18 and continue agitation for another 30 minutes.

The formulations described in Table 2 were sprayed onto both sides of the cellulose/synthetic nonwoven substrate. The sprayed substrates were dried in a through-air oven at a temperature of 320° F. (160° C.) for three minutes. Dry and wet tensile breaking strength and absorption properties were determined as described above, and caliper measurements in millimeters were made with a Thwing Albert Thickness Tester.

VINNAPAS® 192, shown as Formulation #1 in Table 2, is a self crosslinking NMA-containing VAE copolymer dispersion (52% nonvolatiles) commonly used as a binder for airlaid nonwoven substrates, and is shown here as a comparative example. In Table 2, the VINNAPAS® 192 entry reflects addition of NH₄Cl (a catalyst) and AEROSOL® OT dioctyl sodium sulfosuccinate (anionic surfactant) to the VINNAPAS® 192, so that of the nonvolatiles deposited on the substrate, 98 wt % was VAE copolymer/emulsion stabilizers, 1 wt % was NH₄Cl and 1 wt % was AEROSOL® OT.

TABLE 2
Contributions of Individual Components to Physical Properties

| Ingredient | #1 | #2 | #3 | #4 | #5 | #6 |
|---|---|---|---|---|---|---|
| VINNAPAS ® RB18 | 0% | 100% | 0% | 0% | 96% | 95% |
| Chitosan - Low Mol. Wt. | 0% | 0% | 100% | 0% | 4% | 4% |
| 75%-85% deacetylated | | | | | | |
| SURFYNOL ® 465 | 0% | 0% | 0% | 100% | 0% | 1% |
| VINNAPAS ® 192 | 100% | 0% | 0% | 0% | 0% | 0% |
| % Nonvolatiles of Spray | 10% | 9.50% | 0.40% | 0.10% | 10% | 10% |
| Formulation | | | | | | |

Nonwoven Testing Results

| | | | | | | |
|---|---|---|---|---|---|---|
| Basis Weight grams/m² | 97.10 | 92.40 | 83.38 | 88.20 | 90.89 | 93.30 |
| Add-on (%) | 10.00% | 9.83% | 0.4%* | 0.1%* | 9.66% | 9.67% |
| Caliper (mm) | 1.18 | 1.09 | 1.08 | 1.69 | 1.11 | 1.18 |
| Density grams/cm³ | 0.082 | 0.85 | 0.077 | 0.52 | 0.082 | 0.079 |
| Cross Direction Dry | 2473 | 3036 | 1137 | 895 | 2925 | 3035 |
| Tensile grams/5 cm | | | | | | |
| Peak Strain % | 24.6% | 22.3% | 26.7% | 34.4% | 20.9% | 23.1% |
| Cross Direction Wet | 1215 | 512 | 513 | 303 | 905 | 868 |
| Tensile grams/5 cm | | | | | | |
| Absorption Rate | 1.04 | 0.03 | 0.79 | 1.43 | 0.11 | 0.45 |
| gram/gram/second | | | | | | |

*Theoretical add-on rate - too little material on nonwoven for accurate gravimetric measurement

As shown in the above table, none of the three formulation components by itself provided the essential dry strength, wet strength and absorption characteristics required for the nonwoven substrate, and none was comparable to the standard prior art additive VINNAPAS® 192 in these aspects. However, Formulation #6 (which included all the components) did provide the substrate with acceptable values of all essential physical properties. That this was possible with a very low formaldehyde formulation was surprising, and fortuitous.

### Example 3

### Effect of Chitosan Level on Physical Properties

Table 3 below illustrates the affect of increasing the level of chitosan in the blend formulation. Chitosan was increased from 1% to 5% (dry weight %) and spray applied to the previously described air laid nonwoven substrate. The treated substrates were tested in the same manner as described in Example 1.

TABLE 3
Effect of Chitosan Content on Physical Properties

| Ingredient | #1 | #2 | #3 | #4 | #5 | #6 | #7 |
|---|---|---|---|---|---|---|---|
| VINNAPAS ® RB18 | N/A | 100% | 98% | 97% | 96% | 95% | 94% |
| Chitosan - Low Mol. Wt. | N/A | N/A | 1% | 2% | 3% | 4% | 5% |
| 75%-85% deacetylated | | | | | | | |
| SURFYNOL ® 465 | N/A | N/A | 1% | 1% | 1% | 1% | 1% |
| VINNAPAS ® 192 | 100% | N/A | N/A | N/A | N/A | N/A | N/A |
| % Nonvolatiles of Spray | 10% | 10% | 10% | 10% | 10% | 10% | 10% |
| Formulation | | | | | | | |

Nonwoven Testing Results

| | | | | | | | |
|---|---|---|---|---|---|---|---|
| Basis Weight grams/m² | 89.7 | 89.7 | 95.2 | 91.5 | 96.1 | 94.5 | 92.1 |
| Add-on % | 9.4% | 9.8% | 9.8% | 9.8% | 9.4% | 9.7% | 9.9% |
| Caliper mm | 1.24 | 1.17 | 1.19 | 1.21 | 1.24 | 1.22 | 1.27 |
| Density grams/cm³ | 0.072 | 0.077 | 0.080 | 0.076 | 0.078 | 0.077 | 0.073 |
| Cross Direction Dry | 2250 | 3266 | 3238 | 2977 | 3149 | 2990 | 3149 |
| Tensile grams/5 cm | | | | | | | |
| Peak Strain % | 26.9 | 24.5 | 25 | 24.9 | 25.9 | 24.1 | 23.4 |
| Cross Direction Wet | 1263 | 560 | 715 | 800 | 883 | 855 | 970 |
| Tensile grams/5 cm | | | | | | | |
| Absorption Rate | 1.07 | 0.04 | 0.30 | 0.36 | 0.43 | 0.45 | 0.40 |
| gram/gram/second | | | | | | | |
| Capacity | 13.1 | 10.4 | 10.1 | 10.0 | 10.4 | 9.8 | 10.0 |
| grams/gram | | | | | | | |

As seen in Table 3, increasing levels of chitosan in the binder formulation increased wet strength. By itself, the VINNAPAS® RB18 VAE provided 560 grams/5 cm of wet strength to the nonwoven substrate (Formulation #2), but with a 1% addition of chitosan (Formulation #3), the wet strength increased by 28%. At a 5% addition of chitosan (Formulation #7), the wet strength increased by 73% over the nonwoven substrate treated with 100% VINNAPAS® RB18 (Formulation #2).

### Example 4

### Effect of Surfactant on Physical Properties

Table 4 (see attachment) illustrates the effect of wetting surfactant within the binder formulation on the resulting nonwoven substrate properties. Three nonionic surfactants, SURFYNOL® 465, RHODASURF® LA-9, and RHODASURF® BC720 were evaluated along with an anionic surfactant, dioctyl sodium sulfosuccinate (AEROSOL® OT, Cytec Industries Inc., Woodland Park, N.J.).

The nonwoven substrate used in this study was that described in Example 2. The binder formulations were spray applied to the nonwoven substrate and tested in the same fashion as described in Example 2.

TABLE 4
Effect of Surfactant on Physical Properties

| Ingredient | #1 | #2 | #3 | #4 | #5 | #6 |
|---|---|---|---|---|---|---|
| VINNAPAS ® RB18 | 100% | 96% | 95% | 95% | 95% | 95% |
| Chitosan - Low Mol. Wt. | 0% | 4% | 4% | 4% | 4% | 4% |
| 75%-85% deacetylated | | | | | | |
| SURFYNOL ® 465 | 0% | 0% | 0% | 1% | 0% | 0% |
| RHODASURF ® LA-9 | 0% | 0% | 0% | 0% | 1% | 0% |
| RHODASURF ® BC-720 | 0% | 0% | 0% | 0% | 0% | 1% |
| AEROSOL ® OT | 0% | 0% | 1% | 0% | 0% | 0% |

Nonwoven Testing Results

| | | | | | | |
|---|---|---|---|---|---|---|
| Basis Weight grams/m² | 94.20 | 94.10 | 94.40 | 96.10 | 97.30 | 96.20 |
| Add-on % | 10.70% | 11.30% | 10.50% | 10.60% | 10.60% | 11.50% |
| Cross Direction Dry | 2924 | 3359 | 2502 | 3039 | 2835 | 2884 |
| Tensile grams/5 cm | | | | | | |
| Cross Direction Wet | 552 | 1025 | 786 | 1011 | 925 | 782 |
| Tensile grams/5 cm | | | | | | |
| Absorption Rate | 0.02 | 0.16 | 0.03 | 0.54 | 0.83 | 0.79 |
| gram/gram/second | | | | | | |
| Absorption Capacity | 4.0 | 8.4 | 7.9 | 10.5 | 12.2 | 11.7 |
| gram/gram | | | | | | |

Formulations #1 and #2, which contained no surfactant, provided very low absorption rates of 0.02 and 0.16 grams/gram/second respectively. The addition of an anionic surfactant, AEROSOL® OT, was essentially useless for improving the absorption rate, as seen in Formulation #3. It was also poor at improving absorption capacity. In contrast, all of the nonionic surfactants had a significant positive influence on the adsorption rate, as well as the absorptive capacity, without significantly interfering with the tensile properties of the treated substrate.

Use of the anionic AEROSOL® OT also resulted in noticeably lower wet and dry tensile strengths than did the nonionic surfactants. AEROSOL® OT is a well known wetting agent that is typically used to improve the wetting (absorption rate) of substrates that are bound with anionically stabilized dispersions, and it does not interfere with strength development in such applications. However, use of the anionic AEROSOL® OT resulted in inferior wet and dry tensile and very poor absorption properties. Thus, while it may be possible that small amounts of anionic surfactants may be tolerated in compositions of this invention, the one or more surfactant(s) must be at least primarily nonionic and/or cationic and/or amphoteric, and preferably 100% nonionic and/or cationic and/or amphoteric.

### Example 5

### Synergistic Effect of VAE and Chitosan

To clarify the contributions of VAE and Chitosan to wet and dry tensile strength, Whatman No. 4 Chromatography paper was evaluated under four different conditions: treatment with one of three formulations containing additives, and one blank where no treatment was applied. The three formulations were as follows:
#1 100% VINNAPAS® RB18 dispersion @ 9% nonvolatiles
#2 95% VINNAPAS® RB18 dispersion/5% chitosan @ 9% nonvolatiles, adjusted to pH=3.8 with acetic acid
#3 100% chitosan @ 0.45% nonvolatiles, adjusted to pH=3.8 with acetic acid

The chitosan was of low molecular weight and 75%-85% deacetylated. Each of the formulations was applied to the paper as follows:

The paper was dried at 260° F. for 2 minutes to remove moisture and weighed on a four place analytical balance to obtain dry weight. A weighed sample was placed in a pan containing the designated formulation and allowed to soak up the material to saturation. The saturated paper was run through the pressurized nip of an Atlas Padder to remove excess formulation. The treated paper with applied formulation was placed in a convection oven at 300° F. for 5 minutes to dry. The dried samples were removed and reweighed to determine formulation add-on.

Prior to testing, the treated paper was conditioned under controlled temperature and humidity conditions for 24 hours. Samples were cut for tensile measurements in the cross direction (CD) of the paper, and wet tensile and dry tensile measurements were made. The results are shown in Table 5.

Based on the average values for each of the four conditions presented in Table 5, the composition (#2) containing both VAE and chitosan had about 32% higher dry tensile strength than would have been predicted if it were assumed that the strength contributions of the substrate, VAE and chitosan were simply additive. Even more impressively, the wet tensile strength was about 117% higher than would have been expected; more than double the strength. The basis for these conclusions can be seen in the following table, where #1 through #4 indicate the runs detailed in Table 5. The incremental values shown below indicate the calculated individual contributions of VAE or chitosan to strength, and the expected values assume a linear response of strength as a function of amount of VAE or chitosan. As can be seen, the combination of VAE with chitosan provided a remarkable cooperative or synergistic effect for both dry and wet tensile strength.

| | | | | #2 | | | | |
|---|---|---|---|---|---|---|---|---|
| | #1 | #3 | #4 | Expected | Expected | Expected | Actual | Synergistic |
| | VAE | Chitosan | — | VAE | Chitosan | Total | Total | Effect |
| Add-on % | 11.2% | 1.5% | 0.0% | 10.6% | 0.6% | 11.2% | 11.2% | — |
| Dry Tensile (total) | 4505 | 3783 | 2775 | | | 4795 | 6318 | 32% |
| Dry Tensile (incremental) | 1730 | 1008 | | 1644 | 376 | | | |
| Wet Tensile (total) | 231 | 911 | 82 | | | 533 | 1157 | 117% |
| Wet Tensile (incremental) | 149 | 829 | | 142 | 309 | | | |

Although the invention is illustrated and described herein with reference to specific embodiments, the invention is not intended to be limited to the details shown. Rather, various modifications may be made in the details within the scope and range of equivalents of the claims without departing from the invention.

TABLE 5
Effect of Combining VAE and Chitosan

| | | CD Dry | CD Wet |
|---|---|---|---|
| | Add/On | Tensile | Tensile |
| | Wt % | g/in | g/in |
| #1 - VINNAPAS ® RB18 | 10.9 | 4856 | 239 |
| | 10.8 | 4295 | 210 |
| | 12 | 4581 | 224 |
| | 11.3 | 4413 | 230 |
| | 11.9 | 4524 | 229 |
| | 11.3 | 4352 | 254 |
| Ave | 11.4 | 4504 | 231 |
| St Dev | 0.50 | 203 | 15 |
| #2 - VINNAPAS ® RB18 + | 11 | 6522 | 1086 |
| Chitosan | 11 | 6311 | 1035 |
| | 11 | 6203 | 1154 |
| | 11.2 | 6258 | 1298 |
| | 11.1 | 6309 | 1189 |
| | 12 | 6307 | 1179 |
| Ave | 11.2 | 6318 | 1157 |
| St Dev | 0.39 | 108 | 91 |
| #3 - Chitosan | 1.4 | 3493 | 821 |
| | 1.8 | 3621 | 955 |
| | 1.4 | 4059 | 951 |
| | 1.5 | 3613 | 837 |
| | 1.3 | 4057 | 943 |
| | 1.4 | 3857 | 961 |
| Ave | 1.5 | 3783 | 911 |
| St Dev | 0.18 | 243 | 64 |
| #4 - Blank Whatman Paper | 0 | 2467 | 89 |
| | 0 | 3088 | 72 |
| | 0 | 2771 | 84 |
| Ave | 0.0 | 2775 | 82 |
| St Dev | 0.00 | 311 | 9 |

What is claimed:

1. A low-formaldehyde binder composition for increasing wet and dry tensile strength of a nonwoven substrate, wherein the composition comprises
a) an aqueous vinyl acetate ethylene copolymer dispersion employing a nonionic, cationic or amphoteric dispersion stabilizer,
b) chitosan, and
c) one or more surfactants not including the dispersion stabilizer;
wherein the binder composition has a free formaldehyde content no greater than 10 ppm, at least 90 wt % of the one or more surfactants are nonionic, cationic, amphoteric or a combination of these, and the copolymer in the dispersion is free of formaldehyde-generating moieties.

2. The binder composition of claim 1, wherein the dispersion stabilizer is polymeric.

3. The binder composition of claim 1, wherein the dispersion stabilizer is nonionic.

4. The binder composition of claim 1, wherein the dispersion stabilizer comprises polyvinyl alcohol.

5. The binder composition of claim 1, wherein the dispersion stabilizer comprises hydroxyethylcellulose.

6. The binder composition of claim 1, wherein at least 98 wt % of the one or more surfactants are nonionic, cationic, amphoteric or a combination of these.

7. The binder composition of claim 1, wherein the one or more surfactants comprise an alcohol ethoxylate.

8. The binder composition of claim 7, wherein the dispersion stabilizer comprises polyvinyl alcohol.

9. The binder composition of claim 1, wherein the one or more surfactants comprise an ethoxylated acetylenic diol.

10. The binder composition of claim 1, wherein the vinyl acetate ethylene copolymer dispersion is formed by emulsion polymerization initiated by an initiator system that does not generate formaldehyde.

11. The binder composition of claim 1, wherein the vinyl acetate ethylene copolymer dispersion is formed by emulsion polymerization initiated by a redox pair system that does not generate formaldehyde.

12. The binder composition of claim 1, wherein the copolymer constitutes from 99.7 wt % to 77 wt % of nonvolatiles, the chitosan constitutes from 0.2 wt % to 20 wt % of nonvolatiles, and the one or more surfactants constitute from 0.1 wt % to 3 wt % of nonvolatiles.

13. A nonwoven product comprising a nonwoven substrate treated with the composition of claim 1.

14. The nonwoven product of claim 13, wherein the nonwoven substrate is airlaid and comprises synthetic fibers and cellulose.

15. The nonwoven product of claim 13, wherein the nonwoven substrate is a wet laid substrate.

16. A nonwoven wet wipe comprising a nonwoven substrate treated with the composition of claim 1 and subsequently impregnated with an amount of an aqueous composition sufficient to afford a wet texture.

17. The nonwoven wet wipe of claim 16, wherein the aqueous composition is a lotion.

18. The nonwoven wet wipe of claim 16, wherein the nonwoven substrate is airlaid and comprises synthetic fibers and cellulose.

19. The nonwoven wet wipe of claim 16, wherein the nonwoven substrate is a wet laid substrate.
